(19) United States
(12) Patent Application Publication
(10) Pub. No.: US 2017/0267291 A1
(43) Pub. Date: Sep. 21, 2017

(54) LANDSCAPED SURFACE APPLICABLE TO ALL TYPES OF VEHICLE

(71) Applicant: Marc GRANEN ROCA, Bescano (ES)

(72) Inventor: Marc GRANEN ROCA, Bescano (ES)

(21) Appl. No.: 15/516,178

(22) PCT Filed: Oct. 2, 2015
(86) PCT No.: PCT/ES2015/070718

§ 371 Date: Jun. 6, 2017

(30) Foreign Application Priority Data
Oct. 3, 2014 (ES) U201431281

(51) Int. Cl. B62D 25/07; B62D 47/02; A01G 1/04; B60H 1/32; A01G 7/04; A01G 25/06; B60R 11/00; F01N 3/20

(52) U.S. Cl. CPC B62D 25/07; B60R 11/00; B62D 47/02; F01N 3/2066; B60H 1/3233; A01G 7/045; A01G 25/06; A01G 1/048; B60R 2011/004; B60R 2011/0052; B60Y 2200/14

(57) ABSTRACT

Disclosed is a landscaped surface applicable to all types of vehicles, which includes a frame with a settling base that rests on a detachable supporting element or directly on the roof of the vehicle, inside which there are separator partitions and a root development base made of flexible and light hydrophilic material, with a reticular structure that retains a volume of water of between 10 and 30 times the weight thereof, expelling the excess via drainage openings arranged in the lower area of its vertical face of the frame. There is a layer of covering vegetation on the root development base and a mesh secured to a fastening flap in the high part of the frame.

### DESCRIPTION OF THE TECHNICAL FIELD

The invention described in this document refers to a landscaped surface applicable to all types of vehicles, which grants these an intrinsic ecological feature. A group of vehicles also equipped with this invention constitute a large mobile green zone, acting as a lung that regenerates the air inside large urban environments and thus reducing the levels of CO2.

### INVENTION BACKGROUND

Pollution in large cities is in a large part generated by rolling traffic with combustion engines, heating devices in homes, offices, etc., and other industrial facilities that emit gaseous pollutants.

Among others, one of the most damaging gases emitted to the atmosphere is CO2. These emissions degrade the quality of the air in cities, where only the vegetation that is present in urban green areas regenerates the air. However, the number of green areas in cities is clearly insufficient for reaching optimum levels of recycled air.

The obvious solution is to drastically increase the area of green land in urban centres; however, implementing this solution faces two practically unsolvable problems: on the one hand, the lack of free urban space in the centre of cities, which would require demolishing buildings and using this space to plant gardens; and on the other hand, the high cost of urban land, which makes it impossible to yield a profit from building gardens. Therefore, the inventive efforts thus far have focussed on developing vehicles and devices that use fuels that are less damaging to the environment such as biodiesel, hydrogen or natural gas and in developing technologies aimed at consuming less fuel or neutralizing harmful emissions such as using catalytic converters to reduce CO2 or selective catalytic converter reduction systems for reducing NOx and more recently hybrid vehicles.

Compared to minibuses and conventional buses, hybrid buses generate 50% less CO2 and 60% less Nitrogen Oxides (NOₓ).

However, these systems do not regenerate the air; instead, they reduce harmful emissions for the purpose of not degrading the air as much and its scope is limited solely to the vehicle incorporating this technology. We are not disputing that a massive use of these technologies will reduce the level of air pollution; if we do not change the regeneration capacity of the current green areas, the only way to improve the quality of the air is to lower the emission of harmful gases. However, incorporating these technologies in such a large number of vehicles requires an extraordinarily high investment along with inflicting important collateral damages such as, for example, recycling the current fleet of vehicles.

### INVENTION DESCRIPTION

The ultimate goal of the invention described in this document is to improve the quality of the air in large cities. This is accomplished by increasing the capacity for regenerating air by converting or using the exposed surfaces of any type of vehicle operating in the city as a self-sustainable green surface by creating a “mobile garden” that is constantly circulating on the city's roads without needing to use urban land for implementing this solution.

The solution provided can be applied, without limitations, to any vehicle: buses, minibuses, taxis, vans, trams, privately owned vehicles, trucks, etc., without needing to mechanically modify their propulsion systems in any way. This solution can be easily implemented on the current fleet of vehicles at a low cost.

The invention consists of incorporating a landscaped surface on a vehicle without modifying the original configuration of the outer top part of the vehicle, which for example, for buses encompasses an area of about 32 m¹ and about 13 m² for minibuses.

This mobile landscaped surface will play an active role in the regeneration of the air inside the urban environment by acting on the harmful gases of the vehicle itself as well as on the gases emitted by other vehicles since gases will constantly be recycled regardless if the vehicle is being operated or if it is parked.

Based on statistics provided by the State Public Transportation office in 2007, Mexico City Metropolitan Area (MCMA) had a fleet of about 32,476 buses and 20,549 minibuses. By incorporating the landscaped surface described in this invention on all these vehicles we would create a new mobile green space with a surface area of 1,306,369 m² (which is equivalent to the surface area of 117 football fields). From the numbers provided we can conclude that urban transport vehicles owned by MCMA could potentially be transformed into the main air regeneration lung in this metropolitan area and its effect would be added to that of the already existing green areas.

According to data obtained in laboratory tests, a landscaped surface of 32 m2 can absorb 12 kg CO2/year, which means that the aforementioned fleet of buses and minibuses could potentially absorb 3,527,196 kg CO2 in one year, which would result in a measurable improvement in the quality of the air.

Based on an aspect of the invention, the new landscaped surface is placed directly on the outer surface of the roof of any type of vehicle, or on top of an intermediate detachable support element and incorporates a perimeter frame that delimits a landscaped surface where a variety of plants resistant to harsh environmental conditions are grown and which would hardly require any maintenance.

This frame includes a bottom settling base that operationally rests on the intermediate element or on the roof of the vehicle and is fastened to it using bolts or rivets.

Inside the area delimited by the frame, a series of immobilizing partitions are arranged to prevent elements that comprise the landscaped surface from sliding during emergency turns and braking actions or when the vehicle makes a steep turn.

The immobilizing partitions are built using T or L section profiles, where the horizontal section acts as the settling base, resting on the vehicle and fixed to it using bolts or rivets. On the other hand, the vertical section of the profile, which in itself constitutes the partition, preferably incorporates a series of small diameter drill holes that immobilize the landscaped surface in the horizontal plane while allowing water to flow freely.

The perimeter frame incorporates drainage holes at its bottom side, arranged at equal distances throughout its entire length, which help drain the water that accumulates inside it; for example, when rain falls on the vehicles.

In this sense, it is worth mentioning that the entire area defined by the frame, including the separator partitions, is covered by a waterproof layer that prevents the vehicle body from corroding as well as water from filtering inside the vehicle.

The internal area of the perimeter frame, which has been conveniently treated with waterproofing material, houses a root base comprised of a hydrophilic, flexible and light material with a polyurethane foam type reticular structure that retains a volume of water between 10 and 30 times its weight and drains the excess water through the drain holes that are arranged on the frame that encloses it. This will allow plants to take roots and grow by maintaining an optimum level of humidity of the substrate.

The root base is entirely covered by a dense layer of low vegetation, preferably Sedum or other creeping plants that grow directly over it and which will comprise most of the landscaped surface.

This layer of creeping vegetation will also protect the root base against solar UV radiation.

A mesh coupled to a fastening flap in the perimeter frame is installed over the root base.

This mesh secures the landscaped surface preventing it from accidentally becoming extracted from the perimeter frame by the action of the aerodynamic forces the vehicle is subjected to when it is being driven. This mesh is hidden below the layer of creeping vegetation. A series of taller plants are arranged over the layer of creeping vegetation, which extend over the perimeter frame and can be seen from the sides of the vehicle. These plants are rooted directly in the root base, for which several cuts are made to the base and cuttings or whole plants are inserted in each of these cuts.

Based on another aspect of the invention, the landscaped surface incorporates a series of LED panels that are conveniently distributed along the landscaped surface and shine red and blue lights on the plants. These lights help the plants growth and bloom. The panels are powered directly by the vehicle's battery. As an option, they can also be powered by a supplementary power supply system that uses photovoltaic panels built-in to the vehicle itself.

Another aspect of the invention addresses the mycorrhization of the landscaped surface. Mycorrhizal fungi are integrated in the root base and establish a mutualistic relationship with the root of the plants by providing mineral nutrients and water to the roots and obtaining carbohydrates and vitamins from the plants. Fungi are not able to synthesize these carbohydrates and vitamins by themselves but plants can thanks to photosynthesis as well as other internal reactions.

Another aspect of the invention addresses the incorporation of an independent watering system for the landscaped surface. This aspect of the invention can be implemented as long as the vehicle has an air conditioning system and/or is driven by a combustion engine with SCR (Selective Catalytic Reduction) since both of these systems are capable of generating water as a residual product.

In any case and based on the invention, the vehicle incorporates a tank that collects the water originating from the air conditioning evaporator or from a water condenser associated with the SCR system. The function of the SCR is to convert the vapour exhausted through the vehicle's exhaust pipe into water.

The system also incorporates an electrical pump that extracts the water that is stored in the tank and pumps it through a line up to the landscaped surface, where a set of drip watering lines are installed between the root base and the layer of creeping vegetation. These lines distribute the water uniformly throughout the entire surface and especially to the areas where the rooted plants are planted.

This entire assembly can be installed on the structure of a conventional vehicle at minimal cost or it may even be built-in to the vehicle directly by the manufacturer. The assembly can also be installed using a support structure attached to the original roof in cases where the vehicle does not provide a proper settling base. In any case, the invention may be incorporated to any fleet of vehicles without needing to modify the engines of the vehicles that incorporate this new landscaped surface.

Apart from improving the quality of the air we breathe, another improvement directly associated with the invention when it is applied on a large scale is the decrease in the urban heat or island effect in the city, given that the solar energy received is transformed and dissipated by the photosynthesis processes thus preventing it from being absorbed by the concrete and other materials commonly found in cities, which are highly capable of absorbing heat.

### DESCRIPTION OF A PRACTICAL EXAMPLE

This example of the embodiment illustrates the invention applied to different vehicles.

FIG. 1 shows a view of the new device installed on a tram.

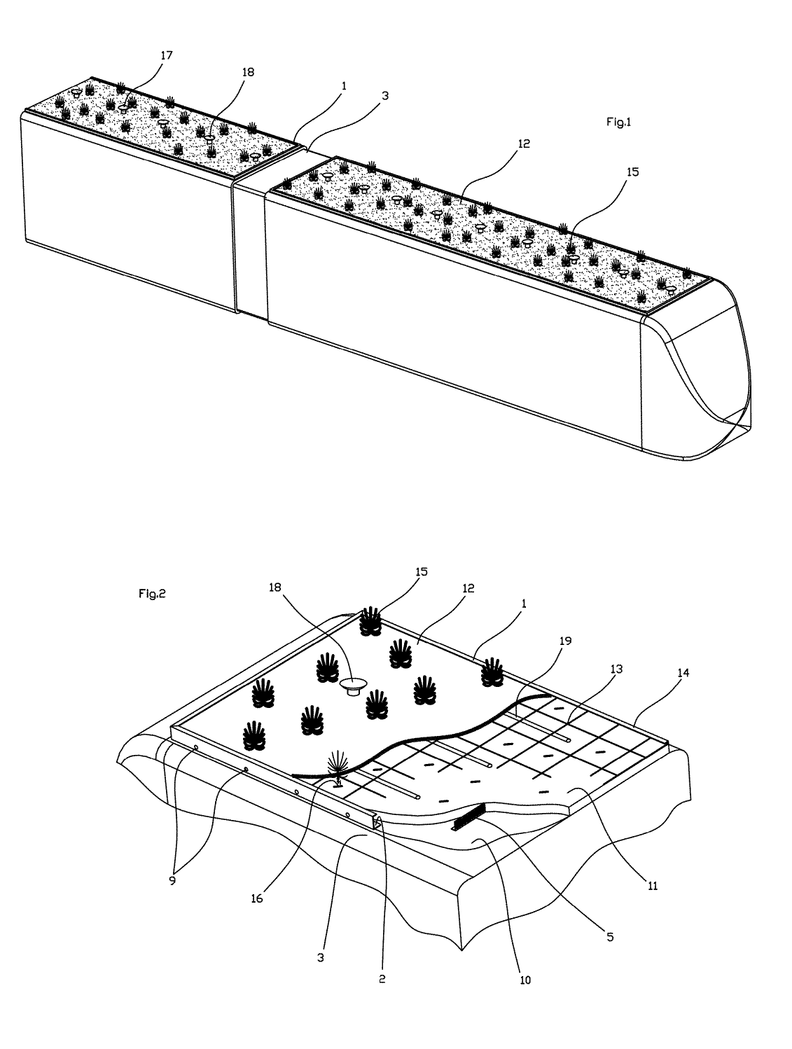

FIG. 2 shows a section view of the landscaped surface based on the invention.

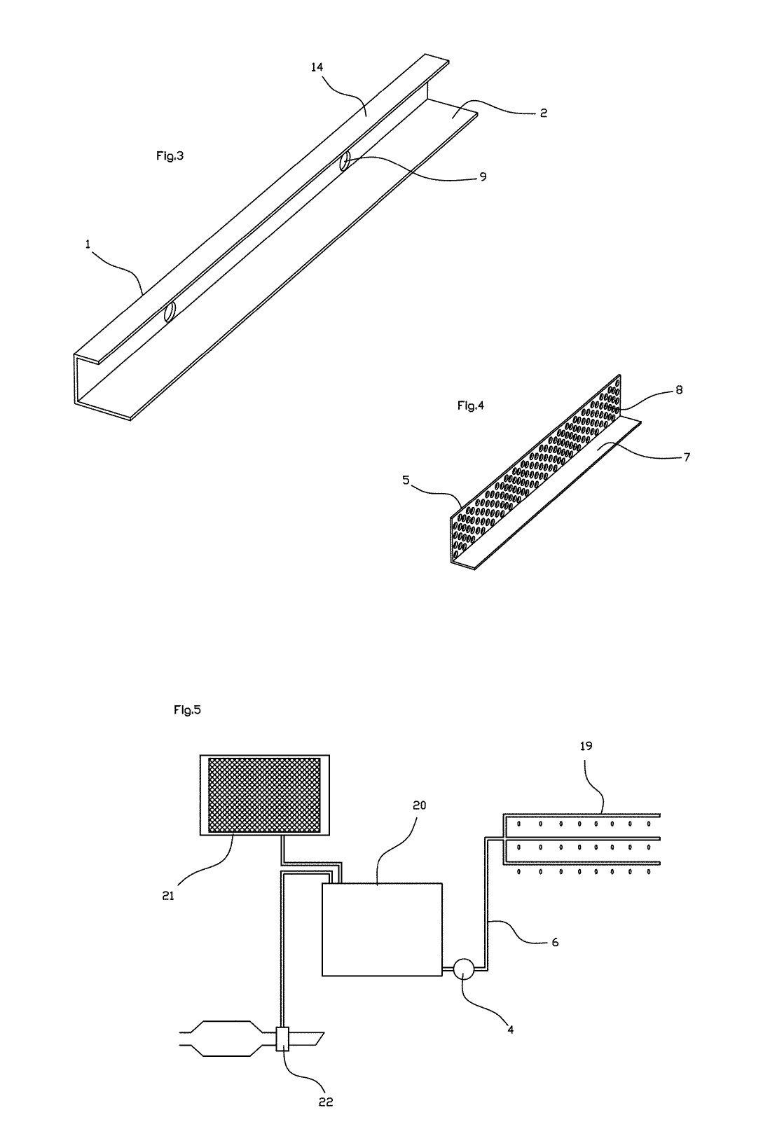

FIG. 3 and FIG. 4 respectively show a view of the profiles that comprise the separator partitions and the frame.

FIG. 5 shows a diagram of the independent watering system based on the invention, in an ideal case applied to a combustion vehicle that incorporates an air conditioning system and SCR.

This innovative landscaped surface includes a frame (1) with a settling base (2) that rests on the roof (3) of the vehicle and is bolted to it.

The frame (1) extends along the entire contour of the roof of the vehicle, but bordering those functional elements that are present on the roof such as sunroofs, air conditioning devices or tanks, delimiting the area where the plants will grow. The separator partitions (5) are installed inside this area, arranged transversely to the direction of travel of the vehicle.

These separator partitions (5) include a series of holes (8) that reduces its weight and facilitates draining the excess water inside the landscaped surface as a result of watering and rainfall.

The frame (1) has drain holes (9) arranged in the lower area of its vertical face, which are used for draining the excess water. This way we prevent excess water from accumulating as well as excess weight from accumulating on top of the vehicle.

The area defined by the frame (1) and the separator partitions (5) incorporates a waterproof layer (10) for the purpose of preventing water from filtering inside the vehicle as well as the metal from corroding.

Inside the frame (1), when the partitions (5) have already been installed and the waterproof layer (10) has been applied, a root base (11) is inserted, which in the illustrated example consists of a sheet of VYDRO® foam that will retain a certain amount of water and will evacuate the excess water through the drain holes (9).

A layer of creeping vegetation (12) is planted on the root base (11) that is comprised of a series of SEDUMS sods, which in turn protect the root base from UV rays.

On the root base (11) and the layer of creeping vegetation (12), there is a mesh (13) connected to a fastening flap (14) that is located at the high part of the perimeter frame (1), which safely secures the assembly. This mesh (13) is quickly covered by the creeping vegetation (12), hiding it from view.

Cuts (16) are made to the root base (11) where root cuttings or taller plants (15) are planted. These plants extend over the layer of creeping vegetation (12) and can be seen from the sides of the vehicle.

The landscaped surface incorporates blue (18) and red (17) LED panels that shine their light on the plants. The blue light helps the Sedums as well as the root cuttings to grow, while the red LEDs notably enhance the plant's ability to bloom. For this reason, there are more blue LEDs than red ones.

The Sedums (12) and root cuttings (15) are inoculated with micorrhizal fungi from the basidiomycetes division initiated at the root base (11).

According to the illustrated example shown in FIG. 5, which shows the invention installed on a bus with an air conditioning system and SCR (Selective Catalytic Reduction) system for reducing NOx emissions, the invention incorporates an independent system for watering the landscaped surface.

These systems include a water tank (20) that collects water originating from the air conditioning system's evaporator (21) or from a condenser (22) that is installed at the outlet of the SCR system (25), which turns the water vapour that is generated by the system into water. The system also incorporates a water pump (4) that extracts the water that is stored in the tank (20) and pumps it through a line (6) up to the landscaped surface, where a set of drip watering lines (19) are installed between the root base (11) and the layer of creeping vegetation (12).

### REFERENCE LIST

1. Perimeter frame
2. Frame settling base
3. Vehicle roof
4. Water pump
5. Immobilizing partitions
6. Water lines
7. Partition settling base
8. Holes on the partition
9. Drain holes
10. Waterproof layer
11. Root base
12. Creeping vegetation
13. Mesh
14. Frame fastening flap
15. Plants/Cuttings
16. Root cuts
17. Red LED panel
18. Blue LED panel
19. Drip watering lines
20. Water tank
21. A/C evaporator
22. SCR condenser
23. Water pump

1-7. (canceled)

8. Landscape surface for use on a vehicle, comprising: a frame (1) with a settling base (2) that rests on a detachable supporting element or directly bolted to a roof (3) of the vehicle, inside which there are separator partitions (5) and a root development base (11) made of hydrophilic, flexible and light material, with a polyurethane foam type reticular structure that retains a volume of water between 10 and 30 times its weight, expelling the excess water via drainage openings (9) arranged in a lower area of a vertical face of the frame (1), further comprising on a root base (11) a layer of creeping vegetation (12) and a mesh (13) secured to a fastening flap (14) that is located at a high part of the frame (1).

9. The landscape surface of claim 8, where cuts (16) are made to the root base (11) and where root cuttings or taller plants (15) are planted, which extend over the layer of creeping vegetation (12) and can be seen from the sides of the vehicle.

10. The landscape surface of claim 8, which incorporates blue (18) and red (17) LED panels that shine their lights on the plants.

11. The landscape surface of claim 8, where the creeping vegetation (12) and the root cuttings and plants (15) are inoculated with micorrhizal fungi at the root base (11).

12. The landscape surface of claim 8, which incorporate an independent watering system comprised of a water tank (20) and a water pump (4) that extracts the water that is stored in the tank (20) and pumps it through a line (6) up to the landscaped surface, where a set of drip watering lines (19) are installed between the root base (11) and the layer of creeping vegetation (12).

13. The landscape surface of claim 8 in that, if the vehicle is equipped with an air conditioning system or SCR (Selective Catalytic Reduction) system used for reducing NOx emissions, the water in the tank (20) originates from the air conditioning system's evaporator (21) or from a condenser (22) that is installed at the outlet of the SCR system (25) and which turns the water vapour that is generated by the system into water.

14. The landscape surface of claim 8, where the separator partitions (5) have a series of holes (8) drilled through them.

15. The landscape surface of claim 8, wherein the creeping vegetation is Sedum.

16. The landscape surface of claim 9, which incorporates blue (18) and red (17) LED panels that shine their lights on the plants.

17. The landscape surface of claim 9, which incorporate an independent watering system comprised of a water tank (20) and a water pump (4) that extracts the water that is stored in the tank (20) and pumps it through a line (6) up to the landscaped surface, where a set of drip watering lines (19) are installed between the root base (11) and the layer of creeping vegetation (12).

18. The landscape surface of claim 10, which incorporate an independent watering system comprised of a water tank (20) and a water pump (4) that extracts the water that is stored in the tank (20) and pumps it through a line (6) up to the landscaped surface, where a set of drip watering lines (19) are installed between the root base (11) and the layer of creeping vegetation (12).

19. The landscape surface of claim 11, which incorporate an independent watering system comprised of a water tank (20) and a water pump (4) that extracts the water that is stored in the tank (20) and pumps it through a line (6) up to the landscaped surface, where a set of drip watering lines (19) are installed between the root base (11) and the layer of creeping vegetation (12).

20. The landscape surface of claim 12 in that, if the vehicle is equipped with an air conditioning system or SCR (Selective Catalytic Reduction) system used for reducing NOx emissions, the water in the tank (20) originates from the air conditioning system's evaporator (21) or from a condenser (22) that is installed at the outlet of the SCR system (25) and which turns the water vapour that is generated by the system into water.

21. The landscape surface of claim 9, where the separator partitions (5) have a series of holes (8) drilled through them.

22. The landscape surface of claim 10, where the separator partitions (5) have a series of holes (8) drilled through them.

23. The landscape surface of claim 11, where the separator partitions (5) have a series of holes (8) drilled through them.

24. The landscape surface of claim 12, where the separator partitions (5) have a series of holes (8) drilled through them.

25. The landscape surface of claim 13, where the separator partitions (5) have a series of holes (8) drilled through them.

26. The landscape surface of claim 15, where the separator partitions (5) have a series of holes (8) drilled through them.

27. Landscaped surface applicable to all types of vehicle which is comprised of a frame (1) with a settling base (2) that rests on a detachable supporting element or directly bolted to the roof (3) of the vehicle, inside which there are separator partitions (5) and a root development base (11) made of hydrophilic, flexible and light material, with a polyurethane foam type reticular structure that retains a volume of water between 10 and 30 times its weight, expelling the excess water via drainage openings (9) arranged in the lower area of the vertical face of the frame (1). On the root base (11) there is a layer of creeping vegetation (12), preferably Sedum, and a mesh (13) secured to a fastening flap (14) that is located at the high part of the frame (1).
